(19) United States
(12) Patent Application Publication
(10) Pub. No.: US 2008/0033771 A1
(43) Pub. Date: Feb. 7, 2008

(54) Ticket upgrade self-serve kiosk

(75) Inventor: Stacey V. Barry, Arlington, VA (US)

Correspondence Address: RADER FISHMAN & GRAUER PLLC, LION BUILDING, 1233 20TH STREET N.W., SUITE 501, WASHINGTON, DC, 20036, US

(73) Assignee: Premier Upgrades Inc, Arlington, VA (US)

(21) Appl. No.: 11/878,977

(22) Filed: Jul. 30, 2007

Related U.S. Application Data
(60) Provisional application No. 60/835,092, filed on Aug. 3, 2006.

(51) Int. Cl. G06Q 99/00; G06Q 30/00

(52) U.S. Cl. 705/5; 705/39

(57) ABSTRACT

An on-site kiosk that offers ticket upgrades. A seating upgrade for an attendee at an event being held at a given venue may entail receiving an indication that the attendee desires a seating upgrade while the event is in progress. An attendee scans a ticket to be relinquished in favor of an upgrade, and a series of interfaces convey seating that is available for the event. This may entail an initial graphical display of the seating chart for the venue (e.g., for the stadium, arena, theatre, etc.) followed by refined displays until the user is ultimately presented with a particular number of seats matching the number to be exchanged for the upgrade. The user confirms the request to obtain the available seating, and provides compensation for the upgrade (e.g., credit card payment, previously accumulated points, etc.). Then tickets for the upgraded seats are immediately printed and provided to the attendee.

### CROSS REFERENCE TO RELATED APPLICATIONS

This application claims priority to previously filed U.S. provisional patent application Ser. No. 60/835,092, entitled Ticket Upgrade Self-Serve Kiosk and filed on Aug. 3, 2007, the entire contents of which are hereby incorporated by reference.

### BACKGROUND OF THE INVENTION

1. Field of the Invention

This invention relates generally to ticket upgrading and more particularly to a kiosk for upgrading tickets to obtain improved seats while an event is in progress.

2. Description of the Related Art

Conventional techniques and technology for ticket upgrading have been found to be variously inadequate.

Currently there are several stadiums where patrons are allowed to upgrade for free because a cost effective, user friendly method of charging and distributing upgrades has not been available.

One suggested system would require the use of a portable handheld device in order to get upgrade information and availability to the patron. The cost and difficulty in using these handheld devices is believed to be a serious impediment to owner and/or stadium investment in such systems, as well as user participation.

Kiosks for selling tickets near stadiums are also known, but these kiosks facilitate the sale of new tickets, and do not allow the submission of previously purchased tickets or related ticket upgrades.

### SUMMARY OF THE INVENTION

According to one aspect, the present invention provides an on-site kiosk that efficiently and securely offers ticket upgrades in a user-friendly fashion that does not require the user to possess handheld computing devices or other technology that would present a barrier to participation.

In one embodiment, seating upgrade for an attendee at an event being held at a given venue may entail receiving an indication that the attendee desires a seating upgrade while the event is in progress. This indication may be received at the on-site kiosk, such as through a scanner that allows users to scan tickets to start the upgrade process, or by having the user manually indicate the desire to start the upgrade process through a touch screen.

Once the user has scanned a ticket to be relinquished in favor of an upgrade, a series of interfaces convey seating that is available for the event. This may entail an initial graphical display of the seating chart for the venue (e.g., for the stadium, arena, theatre, etc.) followed by refined displays until the user is ultimately presented with a particular number of seats matching the number to be exchanged for the upgrade. The user confirms the request to obtain the available seating, and provides compensation for the upgrade (e.g., credit card payment, previously accumulated points, etc.). Then tickets for the upgraded seats are immediately printed and provided to the user.

The inventory of available seating may be updated as the event progresses. For one, the inventory may include those seats relinquished in favor of an upgrade. Additionally, the inventory may be updated by receiving an indication that a ticket holder has left the event. The latter may be accomplished by having a scanner at an exit location.

The inventory of available seating may also be supplied by ticket holders prior to an event (or during an event), when such ticket holders are unable to make it to the event. This may be done for some form of compensation, and may be provided in connection with an online ticket management system that allows users to register and track their ticket usage, submit tickets to make them available in the upgrade inventory, accumulate points for submitting tickets, purchase other tickets, etc.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a block diagram illustrating an embodiment of a ticket upgrade kiosk in accordance with the present invention.

FIG. 2 is a flow diagram illustrating a process for obtaining an upgraded ticket in accordance with the present invention.

FIG. 3 is a display diagram illustrating an interface for initiating an upgrade request and receiving existing ticket information.

FIG. 4 is a display diagram illustrating an interface for graphically displaying available seating upgrades.

FIG. 5 is a display diagram illustrating an interface for refining selection of seating upgrade options.

FIG. 6 is a display diagram illustrating an interface for receiving confirmation of a seating upgrade.

FIG. 7 is a schematic diagram illustrating a system in which the ticket upgrade kiosk operates.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

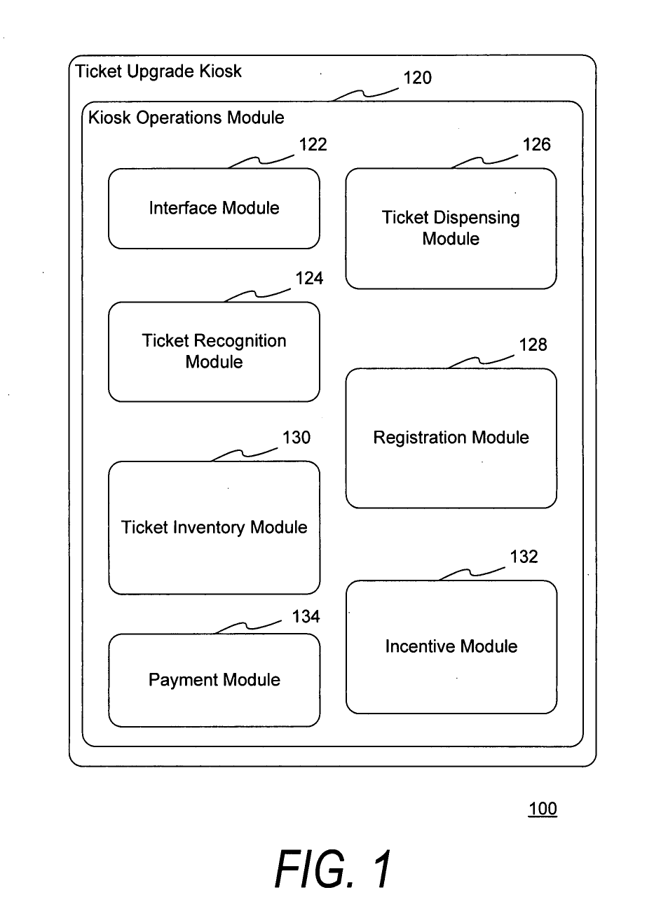

FIG. 1 is a block diagram illustrating an embodiment of a ticket upgrade kiosk 100 in accordance with the present invention.

According to one aspect, the present invention provides an on-site kiosk that efficiently and securely offers ticket upgrades in a user-friendly fashion that does not require the user to possess handheld computing devices or other technology that would present a barrier to participation.

The kiosk 100 may be linked to the central ticketing database that a venue (e.g., stadium) already uses to keep track of attendance when ticket stubs are scanned as fans enter the event. Alternatively, available ticket inventory may be affirmatively communicated to the kiosk by a ticket holder who will not be attending the event, as explained further below.

The kiosk may prioritize the empty seats in the lower level of the stadium so that the best upgrades will be given to the first people in line at the upgrade machine. An initial screen receives an upgrade request and then provides interfaces to receive a selection of a presently available seats. If the fan is satisfied with the upgraded seat(s), then they could provide payment, such as via credit card, for the upgraded ticket(s). The machine would then print the new ticket stub(s) for the upgrade and the fan would be able to use the new stub to get down to the lower level.

The present invention benefits stadiums, teams, and fans alike. By allowing fans an easy and inexpensive method of upgrading to a better view of the event, the satisfaction they experience is increased. An increase in fan satisfaction will have a positive affect on the team, improving team morale and attendance, and increasing corporate sponsorship.

The kiosk 100 may employ a conventional housing as well as input and output devices for conveying and receiving information to and from users. The output devices may include speakers and displays for outputting sounds and graphics useful for interfacing with the user and conveying corresponding ticket upgrade information, and may further include a slot and corresponding technology for dispensing upgraded tickets. The input device preferably comprises a touch screen for receiving user selections, and may further include various input devices such as a keyboard, mouse, microphone and corresponding voice recognition technology, and the like for variously receiving input from users. The interfaces also may include a scanner for scanning indicia such as ticket bar codes, as well as a magnetic stripe reader for reading credit card information, so as to automatically collect information useful for carrying out the ticket upgrade functionality.

The kiosk operations module 120 preferably comprises software that is executed by a processor to carry out the functionality described herein. The kiosk operations module 120 may alternatively comprise firmware or hardware, or a combination of software, firmware and/or hardware. Although one modular breakdown of the kiosk operations module 120 is provided, it is noted that the functionality may be provided by fewer, greater, or differently named modules.

In one embodiment, the kiosk operations module 120 includes an interface module 122, ticket recognition module 124, ticket dispensing module 126, registration module 128, ticket inventory module 130, incentive module 132, and payment module 134.

The interface module 122 includes instructions for driving the display to provide interaction with the user. The kiosk 100 preferably includes a touch screen that accommodates both the display of information related to the ticket upgrade process as well as the receipt of corresponding commands from the user. An example of such displays is described further below.

The ticket recognition module 124 allows an initiation of the upgrade process and identification of the tickets to be upgraded. The ticket recognition module 124 may, for example, interface with a scanning device that allows the user to scan a bar code on existing tickets in order to verify possession of those tickets and to assess the existing tickets for the purposes of determining available upgrades.

The payment module 134 accommodates receipt of payment for a ticket upgrade. This may, for example, be accommodated by receiving credit card information input by the user by swiping a credit card, and corresponding communications with credit card processing, such as through a network connection with the kiosk. The ticket dispensing module 126 accommodates disbursing upgraded tickets to buyers, preferably by printing and outputting tickets for the upgraded seats upon a confirmation and completion of the upgrade process.

The ticket inventory module 130 maintains a database of available seating upgrades, preferably for an event while it is in progress. The database may be kept locally by the kiosk or may be accessed or imported in whole or in part from the centralized ticketing database for the stadium through a network connection or the like.

The ticket inventory module 130 also maintains the upgrade price associated with seats so that the prices may be conveyed to users determining whether to upgrade. These prices may be fixed in advance or may be dynamic, based upon demand for the given event and other factors. For example, the upgrade pricing may change based upon the amount of time that is left in an ongoing event (e.g., the price to go to an upgraded seat may decrease as less time remains in the event), the number of tickets that remain in the particular section or general area of the stadium for the ongoing event, a pattern of upgrade requests suggesting that a high number of upgrades will be sought for the remainder of the event, or the like. Of course, another factor in upgrade pricing may be the face value difference between the upgraded seat and the existing seat.

The inventory of available seating may include seats that have been previously relinquished or that remain un-purchased before the event. The inventory of seating for potential upgrades may also be updated during the course of the event. For example, when a patron upgrades their seats using the kiosk 100 they may relinquish their previously existing seats, which are then available to others for the remainder of the event. Also, when an attendee leaves an event, they may be allowed to make their tickets available for in-event upgrades to other attendees. This may be accommodated by having a scanner (e.g., a permanent scanning device, or security personnel operated handheld scanning devices) at an exit location that allows the person leaving the event to scan their tickets indicating that they are departing. The kiosk 100 may receive updates based upon this departure information and update the available inventory accordingly.

The registration module 128 allows optional registration with the ticket upgrade kiosk. The registration process entails collection of the user's name, address and other information and establishes login credentials that allow recognition of the user without requiring the information to be separately provided. Registration may be imported through participation in related programs. For example, a season ticket holder may have previously registered as a season ticket holder (e.g., online), and that registration may be recognized by the ticket upgrade kiosk. Registration is not required. A one-time upgrade may be allowed in the absence of registration, such as by a person who is not a season ticket holder and who merely wants to upgrade seating for the current event.

The incentive module 132 interfaces with the registration module 128 and the ticket inventory module 130 and manages and maintains the incentive programs associated with the ticket upgrade process. The incentive module 132 may offer differing incentives based upon the amount of time that is left in an ongoing event, the number of tickets that remain in the particular section or general area of the stadium for the ongoing event, a pattern of upgrade requests suggesting that a high number of upgrades will be sought for the remainder of the event, or the like. These factors are similar to those that may affect upgrade pricing. However, pricing and incentive determination may be directly tied together, or they may be separate and distinct determinations. The incentive module 132 can also manage incentive programs that are provided to registered users. For example, in lieu of monetary compensation for submitting a ticket as available, a season ticket holder may instead receive points or a free upgrade to another event that takes place at a later date.

Although a kiosk is preferred because it is believed to be the most convenient for on-site upgrades, the upgrade process as described herein may be carried out at a ticket counter or other centralized location on-site. The ticket counter or other centralized on-site location would include software having the functionality described herein, allowing similar capabilities for receiving existing tickets and immediately dispensing upgraded tickets.

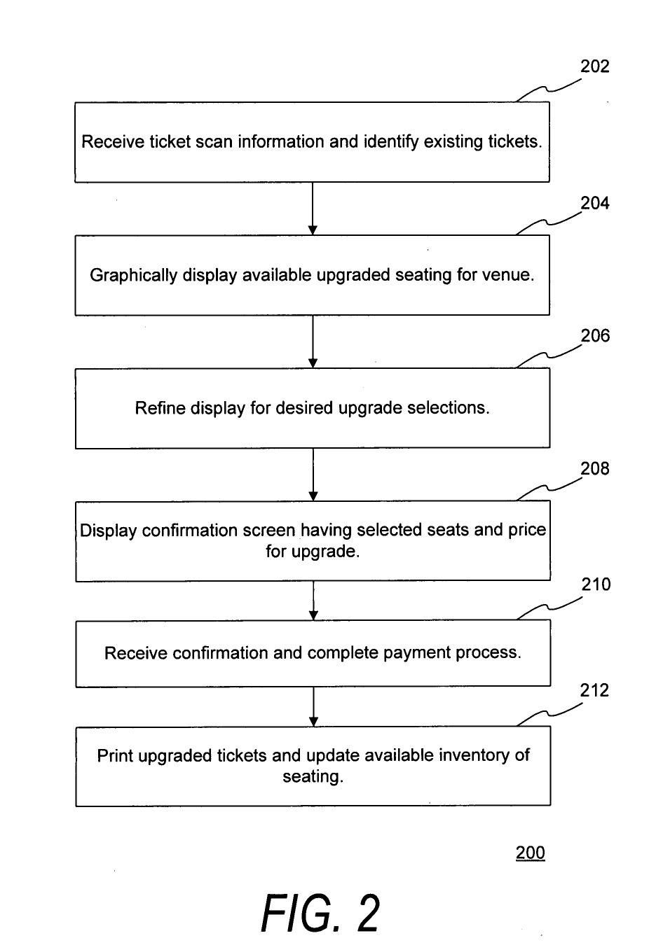

FIG. 2 is a flow chart illustrating an example of a process 200 for obtaining an upgraded ticket in accordance with the present invention.

The user may approach the kiosk and initiate the upgrade process by pressing a touch screen display to indicate that she would like to do so. Alternatively, the user may simply scan the bar code on her existing ticket, which would provide both the indication that she would like to start the upgrade process and an identification of the ticket (or tickets, with multiple scans) to be upgraded. As each ticket is scanned or inserted, the screen will acknowledge that the ticket has been read.

Upon an indication that the initiation process is completed and all of the existing tickets to be upgraded have been scanned, the kiosk prompts display 204 of a map or other graphical display indicating available upgrade seating. For example, a map of the stadium may illustrate a preferred set of locations such as the lower level of the stadium, divided into sections.

Various stages of refinement 206 of the display in accord with the user's selections may also be provided, so that the user may narrow down the selection and ultimately select an upgrade in the most desirable location at the most desirable compensation level (dollars, points, etc.). This will give the customer the ability to choose which area of the stadium they prefer (e.g., some fans may prefer sitting in the end zone, or behind third base, or behind the home team bench.). For example, once a section has been chosen, the screen may display groups rows and list the upgrade price for each group. For example, Rows 1-5 may be $25 per ticket, Rows 6-10 may be $20 per ticket, Rows 11-15 may be $15 per ticket, and Rows 16-20 may be $10 per ticket. Upon choosing a grouping of rows, the user may be presented with more particular information such as the exact row and seat number and the consideration required for the upgrade. Ultimately, the user selects one of the options, and a confirmation screen is displayed 208, identifying the selected seats and the price for the upgrade.

The user confirms 210 the selection such as by pressing a “confirm” button and then completes a payment process. The payment process may entail a conventional credit card payment process wherein the user swipes their credit card and the kiosk interfaces with credit card processing facilities to complete the transaction. Alternatively the user may be a registered user, and may thus have the balance applied to their existing account. Additionally, the compensation does not have to be directly monetary as noted, as points or exchanges of future tickets or the like may be used. There, the registered user may elect to use accumulated points to pay for the upgrade.

Upon satisfactory payment, the upgraded tickets are printed 212 and output for the user. The seats for the existing tickets (prior to the upgrade) may also be made available in the inventory of available seating for the remainder of the event. The kiosk may request input of the former tickets as part of the process, to ensure that multiple versions of the tickets do not result should someone else ultimately select the seats in an upgrade. Alternatively, updgrade tickets may have an updated code indicating that they are legitimate, with the code for the previously issued tickets for the same seats indicating that the tickets are void.

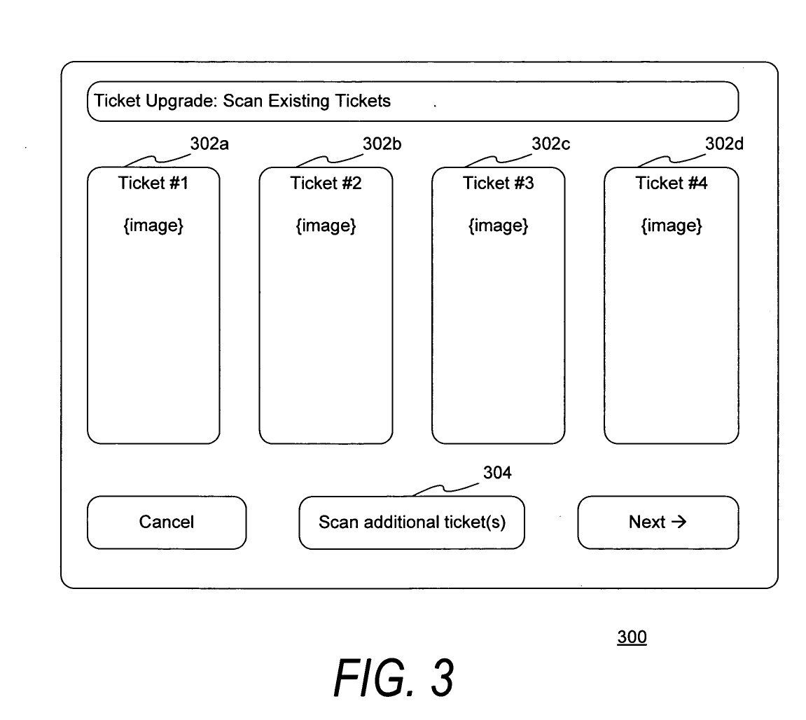

FIGS. 3-6 are display diagrams illustrating examples of interfaces for carrying out the upgrade process.

FIG. 3 is a display diagram illustrating an interface 300 for initiating an upgrade request and receiving existing ticket information. The display updates to provide graphical indication 302a-d of each existing ticket for which an upgrade is sought. The user may seek an upgrade to any number of tickets. If additional tickets are desired, the user may press the “scan additional tickets” button 304 to add another ticket. Once the set of tickets to be upgraded is established, the user may press the next button to navigate to the upgraded seat selection screens.

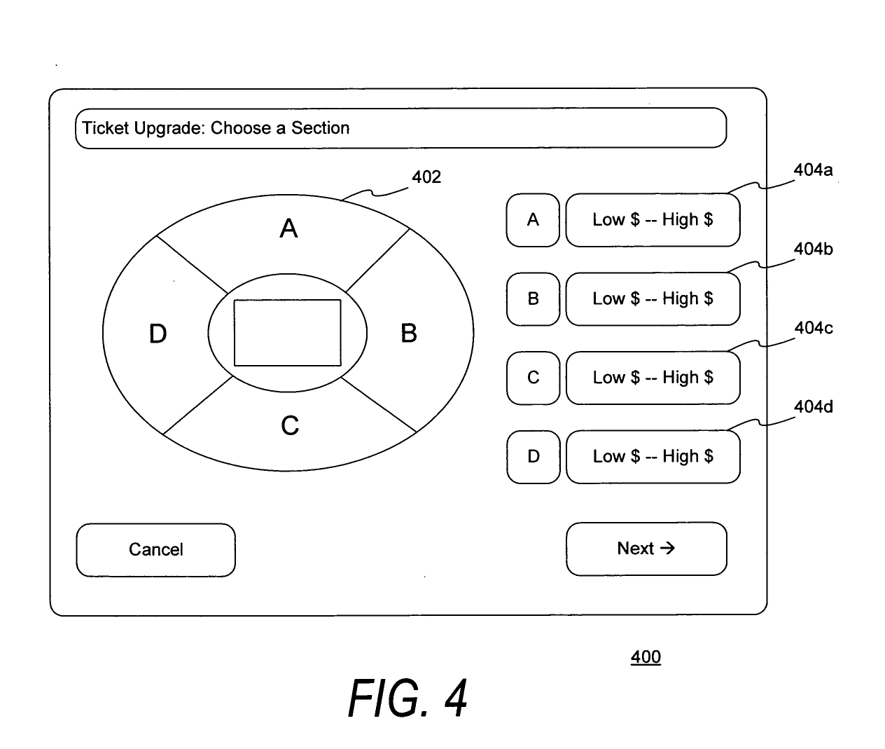

FIG. 4 is a display diagram illustrating an interface 400 for graphically displaying available seating upgrades. A graphical display of the venue (e.g., stadium, or arena, or theatre, etc.) and corresponding seating sections is displayed and can be customized for each venue (e.g., “A” through “D”). Sections which have the requested number of available upgrade seats together will be highlighted, and a series of buttons corresponding to the highlighted sections can be enabled and shown alongside the venue map.

At any time, the user may press the cancel button whereupon the upgrade process terminates and the tickets (if retained) are returned to the user. Alternatively, the user may continue the process, which may involve one or more iterations of refining or “drilling down” to the ultimate selection of the exact number of seats to be upgraded.

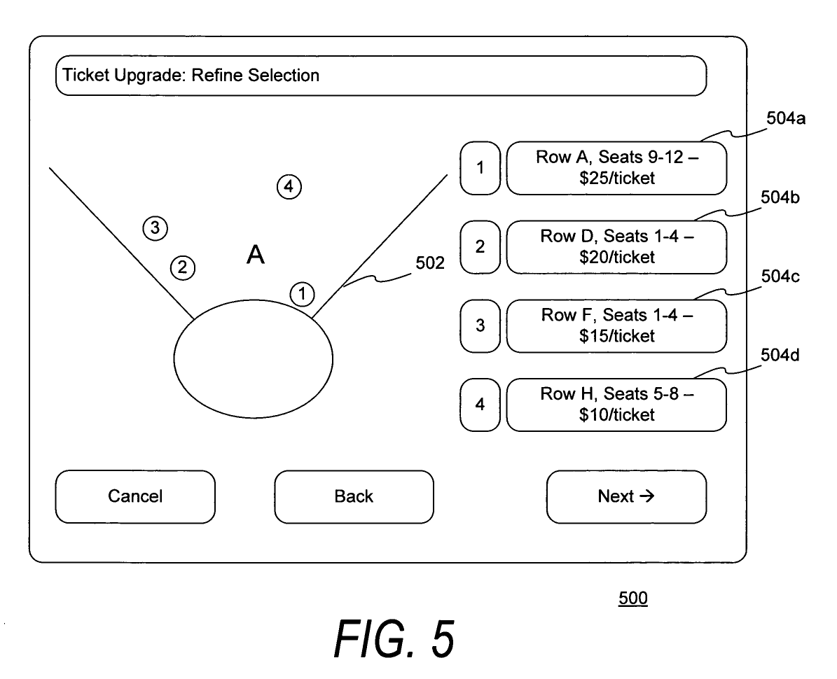

FIG. 5 is a display diagram illustrating an interface 500 for refining selection of seating upgrade options. This screen shows a zoomed in diagram 502 of the section the customer selected from the previous page. Additionally, examples of seats within the section that match the number submitted for upgrade are shown for user selection and displayed alongside the graphical display of the venue. The examples also preferably include a price corresponding to each upgrade option. Additionally, the section may include highlighting (not shown) that illustrates the relative locations of the potential seating upgrades. The user may select one of the buttons (504a-d) to select a group of seats, whereupon the seats are placed on hold for a given period allowing the user to confirm the purchase of the upgrade. If no seats are satisfactory, the user may press the “back” button to go back to the broader view of the venue and repeat the refinement process. Or, as before, the user may hit the cancel button to terminate the upgrade process.

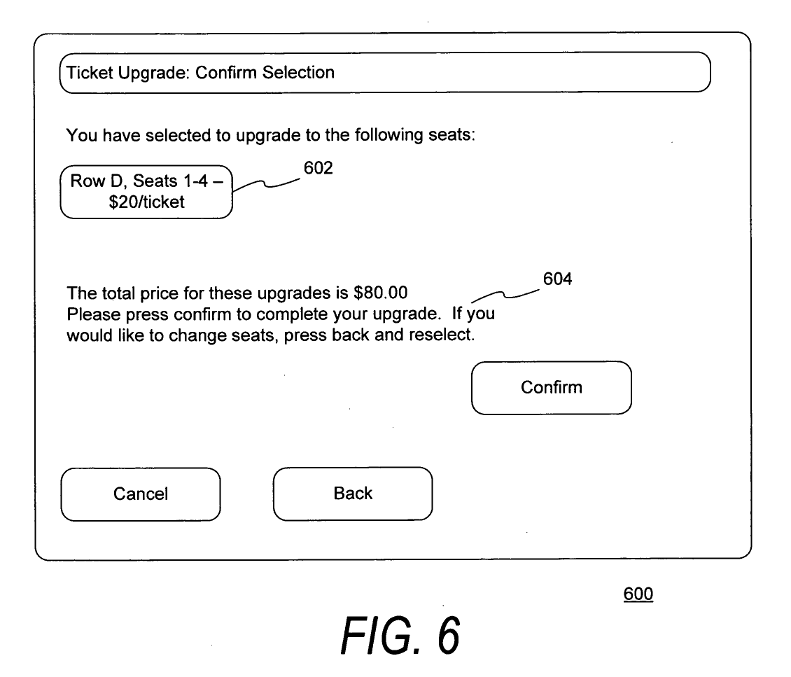

FIG. 6 is a display diagram illustrating an interface 600 for receiving confirmation of a seating upgrade. The seats selected from the previous steps are identified on the screen. A button 602 may allow the user to confirm a view corresponding to the selected seats. An upgrade confirmation message 604 also informs the user regarding the price for the upgrade and requests confirmation of the order. The user may press the confirm button to confirm, or may use the back and cancel buttons as noted previously.

Once the purchase is confirmed, the payment process is completed (e.g., credit card, deduction of points, etc.) and the new tickets are printed and provided to the user.

According to another aspect, the present invention accommodates the realization of new revenue streams related to upgrade fee collection and provides an incentive to users (e.g., season ticket holders) to register with their online ticket management system, provide further information about the games that they are actually attending, and offer seats for upgrade by others when they do not plan to attend or plan to leave an event early.

The venue (or team using the venue for a given type of event) may provide an online ticket management system. A user, whether a single game, partial plan, or season ticket holder, may register with the online ticket management system and as such provide relevant registration information as described. A ticket holder for seating at a given event may at some point post an inquiry as to the compensation available for relinquishing their ticket to make it available in the upgrade system. Most likely, this may be a season ticket holder who realizes that they will not be able to make it to attend the given event on short notice. This would allow them to make the seats available in an upgrade scenario, in lieu of trying to find someone willing and able to use the tickets independently. In exchange for making such tickets available in the upgrade inventory, the user is provided some form of compensation. This may be a monetary refund, points applicable to account provided by the online ticket management system (which may, perhaps, be useable to obtain team apparel or other items through the same site), or upgrade rights to a future event (i.e., give up your ticket for this game, get a better ticket to the next game). When such a transaction is made, the relinquished tickets are made available in the inventory, and the existing tickets are voided so that they cannot be used to enter the venue. The user's account is updated in accord with the confirmed compensation.

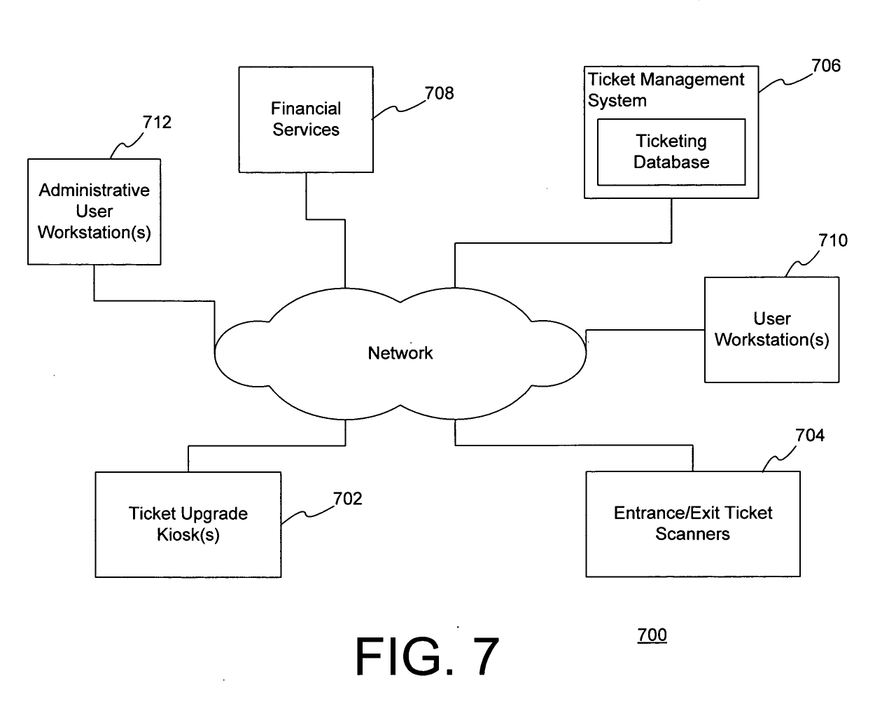

FIG. 7 is a schematic diagram illustrating a system 700 in which the ticket upgrade kiosk 702 operates. The ticket management system 706 for a given venue incorporates a ticketing database. When tickets are scanned at the entrance to the stadium (704), they are marked as “not available to upgrade” in the ticketing database. The various systems may be connected by wireless or wired networks, public or private in order to exchange the necessary information.

When a customer uses an upgrade kiosk 702, it may connect to the ticketing database to gather an update regarding which seats are available to upgrade. Once a customer has selected a section of rows, the best available seats in the section are then placed on hold in the database for a determined amount of time. Once a customer has confirmed and purchased the tickets, the tickets are then marked as “not available to upgrade” in the database. Similarly, when a patron leaves the venue, they may have their ticket scanned to allow it to go from “not available” to “available to upgrade” status.

Other connections are also illustrated to carry out the payment functionality, as well as the online participation component. The kiosk (or ticket management system) may connect to financial services 708 such as a credit processing center to authenticate and charge the customer's credit card.

A user may also operate a workstation 710 equipped with Internet access and conventional browsing capability to navigate to the online ticket managing system, enter their login credentials (or register), submit tickets as available for the upgrade process, or otherwise manage their ticket account. Since the registered user, particularly the season ticket holder, provides registration information that may include an e-mail address and a mailing address, registration affords the team the opportunity to contact ticket buyers (and those who use the ticket upgrade system) to convey reminders, promotional messages, and the like. For example, a season ticket holder may receive useful reminders to renew their ticket plans. Also, a person who has used the upgrade system may receive offers to receive seats identical or similar to their upgraded seats for a future event.

A third party (e.g., Premier Upgrades, Inc.) may operate the kiosk operation and may remotely access the kiosk in order to further payment, collect upgrade information for kiosks at the multiple venues managed by the third party, or otherwise interface with the various systems as described. Also, a team representative may operate an administrative user workstation 712 to allow management of the various system parameters, including but not limited to pricing and availability of upgrade options, checking inventory of available seating, etc.

The present invention accommodates the realization by stadium operators, team owners and ticket holders of new revenue streams related to upgrade fee collection as well as the increased value in tickets. The stadium/owner may offer those who submit tickets as available for upgrade a financial incentive in the form of a portion or percentage of the revenue generated from selling the ticket upgrades. Ordinarily, when a ticket holder realizes that he or she will not use tickets, there is no incentive to inform the stadium as to the availability of the seats. With the present invention, the ticket holder may be given a financial or other incentive to make the tickets available. Moreover, since the ticket upgrade service is hosted at the stadium, it will be perceived to both buyers and sellers as a more secure alternative to any other secondary markets, such as online auction sites. The stadium will also see an increase in revenues from the upgrade fees and the opportunity to resell the upper level seat after the patron has upgraded.

As indicated above, the present invention may be variously embodied. For example, a kiosk in accordance with the present invention uses processing hardware, memory, a display and means for scanning or otherwise receiving tickets and other input and is configured according to the functionality described herein. Alternatively, software for carrying out the described functionality when executed by a kiosk may also be provided in accordance with the present invention.

Thus embodiments of the present invention produce and provide a self service kiosk for patrons of an event to upgrade their seats. Although the present invention has been described in considerable detail with reference to certain embodiments thereof, the invention may be variously embodied without departing from the spirit or scope of the invention.

1. A method for seating upgrade for an attendee at an event being held at a given venue, the method comprising:
receiving an indication that the attendee desires a seating upgrade, the indication being received at the given venue, while the event is in progress;
displaying an available seat for the event in response to the indication that the attendee desires the seating upgrade;
receiving from the attendee a request to obtain the available seat following the display of its availability; and
outputting for physical possession by the attendee a tangible confirmation that the attendee has obtained the available seat.

2. The method of claim 1, wherein displaying the available seat, receiving the request to obtain the available seat, and outputting the tangible confirmation are performed by an on-site kiosk present within the given venue.

3. The method of claim 2, wherein receiving an indication that the attendee desires a seating upgrade comprises the attendee passing a bar code on a ticket for their existing seat over a scanner provided by the on-site kiosk.

4. The method of claim 3, wherein displaying an available seat for the event comprises providing a graphical depiction of a seating map for the given venue and corresponding indication of available seats within the seating map.

5. The method of claim 1, wherein the available seat is part of an inventory of available seats, and wherein an exit scanner allows a departing attendee to scan a ticket to make their seat available in the inventory of available seats when they leave the given venue.

6. The method of claim 1, wherein the available seat is part of an inventory of available seats, and wherein a ticket holder makes their seat available in the inventory of available seats before the event takes place.

7. The method of claim 6, wherein the ticket holder is compensated for making the previously purchased seat available in the inventory of available seats.

8. The method of claim 1, wherein the tangible confirmation is a ticket.

9. The method of claim 1, wherein the request to obtain the available seat is a request to purchase the available seat.

10. A system for seating upgrade for an attendee at an event being held at a given venue, the system comprising:
means for receiving an indication that the attendee desires a seating upgrade, the indication being received at the given venue, while the event is in progress;
means for displaying an available seat for the event in response to the indication that the attendee desires the seating upgrade;
means for receiving from the attendee a request to obtain the available seat following the display of its availability; and
means for outputting for physical possession by the attendee a tangible confirmation that the attendee has obtained the available seat.

11. The system of claim 10, wherein the means for receiving an indication that the attendee desires a seating upgrade comprises receiving bar code information on a ticket for an existing seat.

12. The system of claim 10, wherein the available seat is part of an inventory of available seats, and wherein an exit scanner allows a departing attendee to scan a ticket to make their seat available in the inventory of available seats when they leave the given venue.

13. The system of claim 10, wherein the available seat is part of an inventory of available seats, and wherein a ticket holder makes their seat available in the inventory of available seats before the event takes place.

14. An on-site kiosk for providing seating upgrades for attendees at an event being held at a given venue, the on-site kiosk comprising:
a ticket recognition module, which receives an indication that the attendee desires a seating upgrade, the indication being received at the given venue, while the event is in progress;
a ticket inventory module, which determines an available seat for the event in response to the indication that the attendee desires the seating upgrade;
an interface module, in communication with the ticket inventory module, which receives from the attendee a request to obtain the available seat following the display of its availability; and
a ticket dispensing module, which outputs for physical possession by the attendee a tangible confirmation that the attendee has obtained the available seat.

15. The on-site kiosk of claim 14, wherein the ticket recognition module receives an indication that the attendee desires a seating upgrade by receiving bar code information on a ticket for an existing seat.

16. The on-site kiosk of claim 14, wherein the available seat is part of an inventory of available seats, and wherein an exit scanner allows a departing attendee to scan a ticket to make their seat available in the inventory of available seats when they leave the given venue.

17. The on-site kiosk of claim 14, wherein the available seat is part of an inventory of available seats, and wherein a ticket holder makes their seat available in the inventory of available seats before the event takes place.
